(19) United States
(12) Patent Application Publication
(10) Pub. No.: US 2013/0026770 A1
(43) Pub. Date: Jan. 31, 2013

(54) ANTI-PANIC OPENING DEVICE WITH SLIDING LATCH

(71) Applicant: Aimone Balbo Di Vinadio, Chiusa San Michele (Torino) (IT)

(72) Inventor: Aimone Balbo Di Vinadio, Chiusa San Michele (Torino) (IT)

(21) Appl. No.: 13/553,626

(22) Filed: Jul. 19, 2012

(30) Foreign Application Priority Data
Jul. 29, 2011 (IT) TO2011A000698

(51) Int. Cl. E05C 1/14

(52) U.S. Cl. 292/174

(57) ABSTRACT

Anti-panic opening device for doors, comprising a left support and a right support bearing respective main control members and a lock mountable on the left support or on the right support, wherein the lock comprises, a base bearing a linear guide extending along a main rectilinear direction, a latch which engages said linear guide and is movable relative to the base along said main direction between a closed position and an open position, wherein the latch has a groove elongated in said main direction, at least one elastic element arranged between the base and the latch, to push the latch towards said closed position, wherein said main control members are articulated to the respective support about an axis orthogonal to said main direction and wherein the main control member of the support associated with the lock has an arm which cooperates with the latch in relation to the thrust.

### CROSS-REFERENCE TO RELATED APPLICATIONS

This application claims benefit of Italian patent application number TO2011A000698, filed Jul. 29, 2011, which is herein incorporated by reference.

### BACKGROUND OF THE INVENTION

1. Field of the Invention

The present invention relates to an anti-panic opening device with sliding latch.

2. Description of the Related Art

An anti-panic opening device typically comprises two supports intended to be fixed to two vertical uprights on opposite sides of a door and a control bar that connects these supports to each other. In one of the two supports a lock is housed, equipped with a latch, being elastically pushed towards a closed position. A movement of the control bar orthogonal to the door drives the movement of the latch towards an open position.

The locks of the anti-panic opening devices may have an oscillating latch or a sliding latch. In the first case the latch is rotatably mounted about a vertical axis and is capable of rotating about said axis between a closed position and an open position. In the second case, the latch moves along a horizontal rectilinear direction between a closed position and an open position.

Locks with a sliding latch are generally more secure than those with an oscillating latch as they offer greater security against burglary attempts carried out by moving the latch to the open position from the external side of the door.

In anti-panic opening devices it is necessary to mount the lock on the support of the left side or on the support of the right side of the door to allow the use of the opening device on doors that open to the right or on doors that open to the left.

There are known anti-panic opening devices with sliding latch locks that can be mounted on the left support or right support of the opening device. However, locks of the known type require configuration operations to adapt the lock according to the right support or to the left support.

### SUMMARY OF THE INVENTION

The present invention aims to provide an anti-panic opening device having a lock with an ambidextrous sliding latch, which can be mounted on the right side or left side of a door indifferently, without carrying out configuration operations of the lock.

According to the present invention, this object is achieved by an anti-panic opening device comprising a left support and a right support bearing respective main control members and a lock mountable on the left support or on the right support, wherein the lock comprises:

a base bearing a linear guide extending along a main rectilinear direction,

a latch which engages said linear guide and is movable relative to the base along said main direction between a closed position and an open position, wherein the latch has a groove elongated in said main direction,

at least one elastic element disposed between the base and the latch, to push the latch towards said closed position,

wherein said main control members are articulated to the respective support about an axis orthogonal to said main direction and wherein the main control member of the support associated with the lock has an arm which extends into said groove and cooperates with the latch (56) in relation to the thrust.

The claims form an integral part of the teaching administered here in relation to the invention.

### BRIEF DESCRIPTION OF THE DRAWINGS

The present invention will now be described in detail with reference to the accompanying drawings, provided purely by way of a non-limiting example, wherein:

FIG. 1 is a front view of a door fitted with an anti-panic opening device,

FIG. 2 is an exploded perspective view of the part indicated by the arrow II in FIG. 1,

FIG. 3 is a partially sectioned perspective view of the part indicated by the arrow III in FIG. 2,

FIG. 4 is an exploded perspective view of the lock indicated by the arrow IV in FIG. 2,

FIGS. 5 and 6 are sections on an enlarged scale along the line V-V of FIG. 1 in the closed position and in the open position, respectively

FIG. 7 is a partially exploded perspective view illustrating a second embodiment,

FIG. 8 is an exploded perspective view of the part indicated by the arrow VIII in FIG. 7,

FIGS. 9 and 10 are sections along the line V-V of FIG. 1 showing the lock in the closed position and in the open position, respectively.

### DETAILED DESCRIPTION

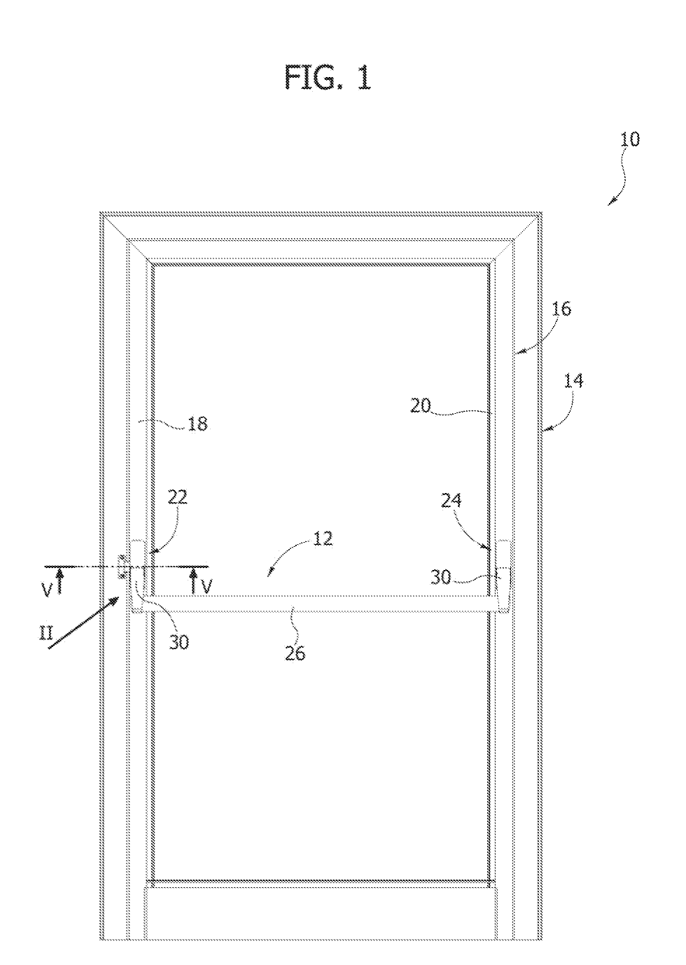

In FIG. 1 a door is indicated with the number 10, equipped with an anti-panic opening device 12. The door 10 comprises a fixed frame 14 and a leaf 16 articulated to the fixed frame 14 about a vertical axis. In the example shown the leaf 16 includes a left upright 18 and a right upright 20 and is articulated to the fixed frame 14 at the right upright 20.

The anti-panic opening device 12 comprises a left support 22 and a right support 24 fixed to the left upright 18 and to the right upright 20, respectively. The supports 22, 24 carry a control bar 26 which can be pressed towards the leaf 16 to drive the opening of the door.

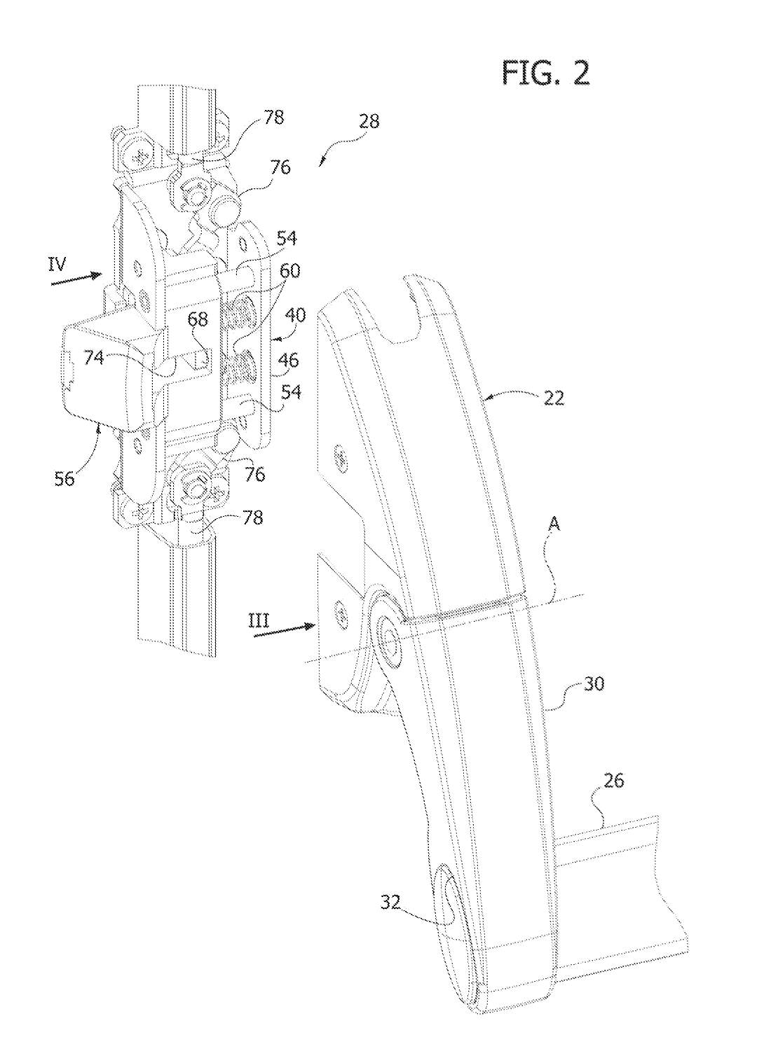

With reference to FIG. 2, the left support 22 is associated with a lock 28. In the case of a leaf articulated to the fixed frame at its left upright, the lock 28 is associated with the right support 24.

Each support 22, 24 carries a respective control lever 30, the control levers 30 being articulated to respective supports 22, 24 around a common horizontal axis A. Each control lever 30 has a hole 32 at its distal end within which a corresponding end of the control bar 26 is inserted.

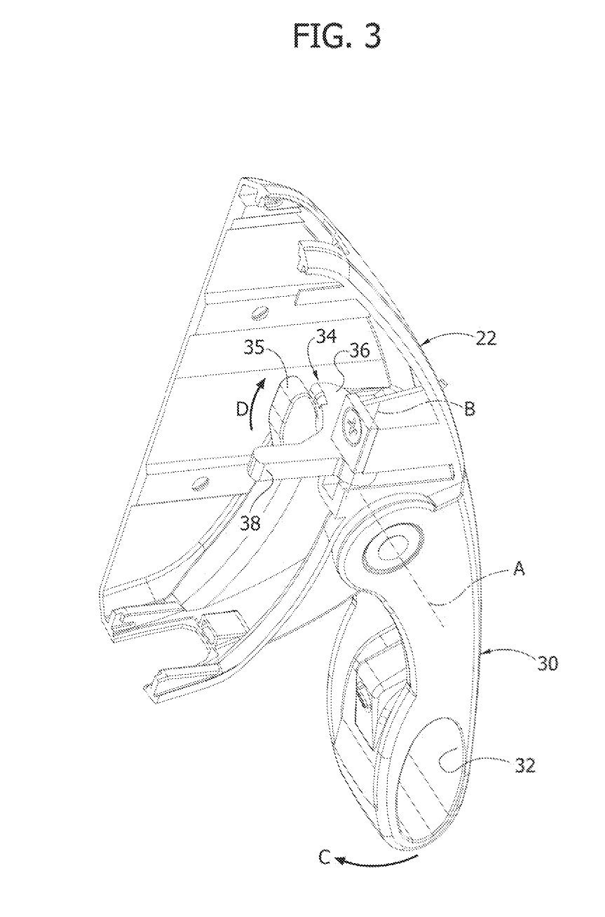

With reference to FIG. 3, each support 22, 24 has a respective main control member 34 which is articulated to the support 22 about an axis B perpendicular to axis A around which the control lever 30 is articulated. In the position of use, the B-axis is usually vertical and parallel to the plane of the leaf 16. The main control member 34 has two arms 36, 38 arranged at 90° to each other. The first arm 36 cooperates with a control projection 35 fixed with respect to the control lever 30.

An oscillation of the lever 30 about axis A in the direction indicated by arrow C in FIG. 3 causes, as a result of contact between the projection 35 and the first arm 36, an oscillation of the control member 34 about the axis B in the direction indicated by the arrow D. The control lever 30 is associated with a spring (not visible in FIG. 3) which tends to keep the lever 30 in an upwards resting position. The second arm 38 of the control member 34 is intended to control the lock 28 in the manner which will be described below.

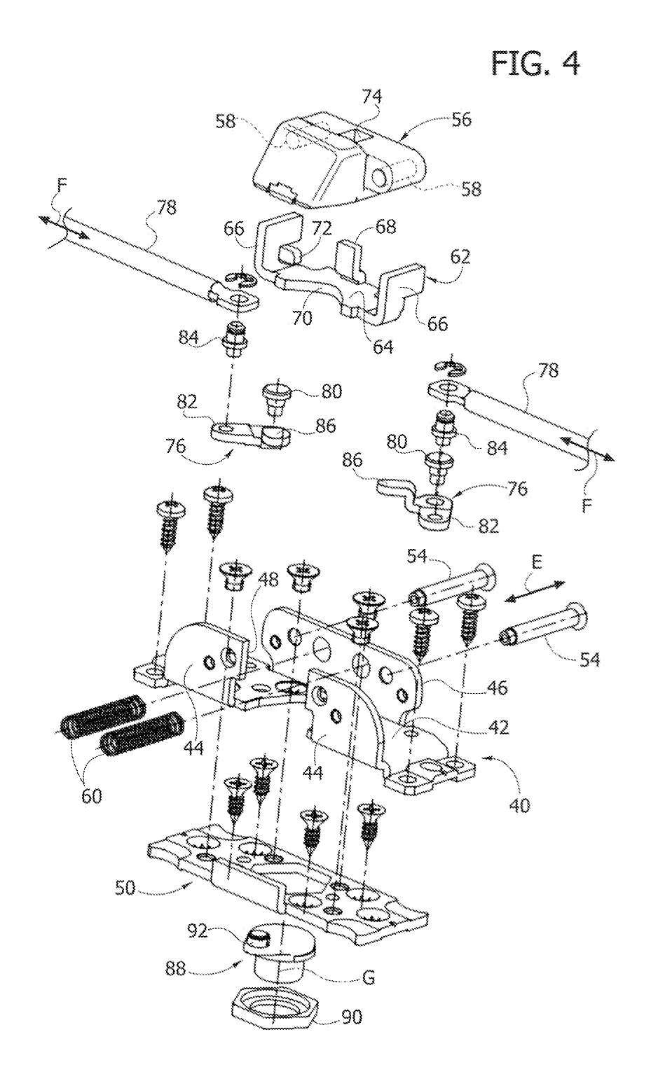

With reference to FIG. 4, the lock 28 comprises a base 40, consisting for example of bent sheet metal, having a bottom wall 42, an outer side wall 44 and an inner side wall 46. The side walls 44, 46 are parallel to each other and the outer side wall 44 has a central opening 48. The base 40 is intended to be fixed to the respective upright 18 or 20 of the leaf 16. The fastening of the base 40 to the upright 18 or 20 can be carried out for example by means of a fastening plate 50.

The base 40 carries a linear guide which extends along the main rectilinear direction indicated by the double arrow E. In the embodiment illustrated in the Figures, the linear guide is formed by two pins 54 parallel to each other and fixed between the side walls 44, 46.

The base 40 carries a latch 56 that engages the linear guide formed by pins 54 and is movable relative to the base 40 along the main direction E between a closed position and an open position. The latch 56 has one end that protrudes through the opening 48 of the outer side wall 44 of base 40. The latch 56 has two holes 58 through which extend respective pins 54. Two helical springs 60 are disposed between the latch 56 and the inner side wall 46 and tend to push the latch 56 towards a closed position.

With reference to FIG. 4, the lock 28 comprises a carriage 62 movable with respect to the base 40 along the main direction E between a resting position and an open position. The carriage 62 has a central part 64 and two wings 66 that protrude at 90° with respect to the central part 64. The central part 64 also has a pin 68, for example with a rectangular cross-section, which protrudes at 90° from the central portion 64 and is centrally located between the wings 66. The central part 64 of the carriage 62 may be provided with a curved edge 70 whose function will become clear below. The wings 66 of the carriage 62 may be provided with respective supporting portions 72 formed by folded portions of wings 66.

The central part 64 of the carriage 62 is disposed between the latch 56 and the bottom wall 42 of base 40. The wings 66 of the carriage 62 extend from opposite sides of the latch 56. The pin 68 of the carriage 62 is inserted into a through groove 74 of the latch 56. The groove 74 is elongated in the main direction E. The connection between the pin 68 and the groove 74 allows freedom of relative movement between the latch 56 and the carriage 62 in the direction E.

Again with reference to FIG. 4, in one embodiment the lock 28 is equipped with two levers 76 which control respective rods 78 movable in directions F orthogonal to the main direction E. Each lever 76 is articulated to the base 40 by means of a first pin 80 and has a first arm 82 articulated at one end of respective rod 78 by a second pin 84. Each lever 76 has a second arm 86 which is in contact with a respective supporting portion 72 of the carriage 62.

In one embodiment, the lock 28 comprises an auxiliary control member 88 rotatable relative to the base 40 about an axis G orthogonal to the main direction E. The auxiliary control member 88 is connected to the fixing plate 50 by means of an element 90 which holds the auxiliary member 88 in the axial direction leaving the auxiliary control member 88 free to rotate about the axis G. The auxiliary control member 88 has an eccentric pin 92 which cooperates in a supporting relationship with the curved edge 70 of the carriage 62 so that the rotation of the auxiliary control member about the axis G causes a movement of the carriage 62 in the direction E from the resting position towards the open position, through the contact between the eccentric pin 92 and the curved edge 70.

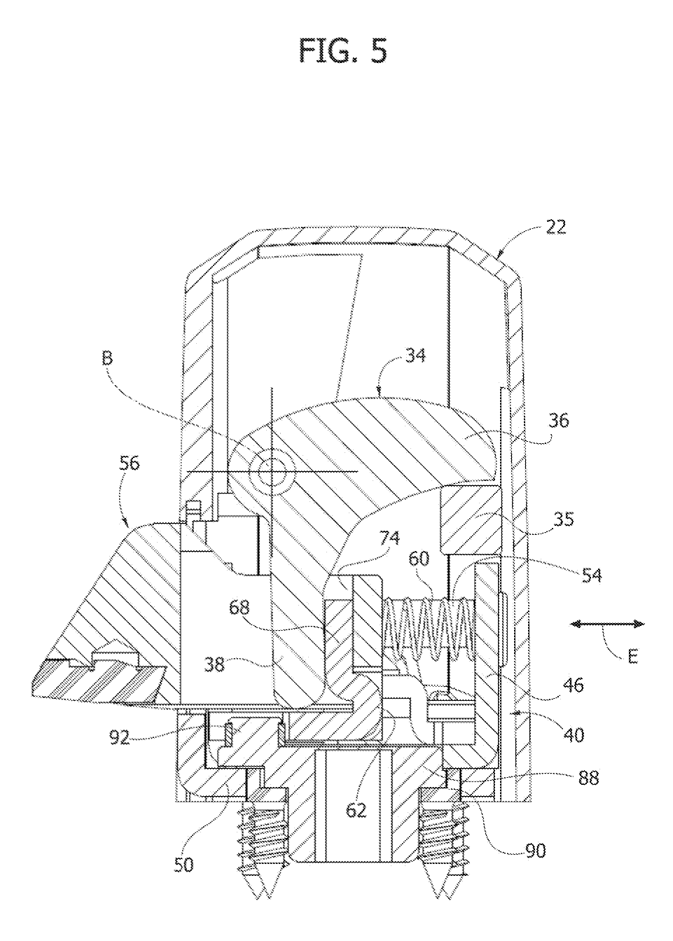

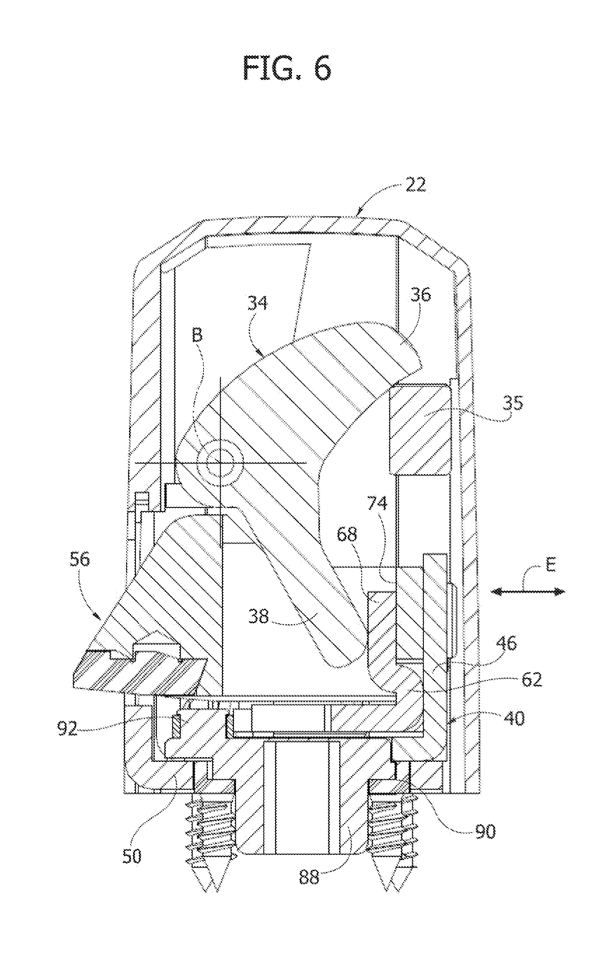

FIGS. 5 and 6 illustrate the lock 28 in the closed position and in the open position, respectively. It may be noted that the B-axis, around which the main control member 34 is articulated, is orthogonal to the main direction E along which the latch 56 and the carriage 62 are movable. The springs 60 push the latch 56 towards the closed position. When the latch 56 is in the closed position (FIG. 5) the trolley 62 is in its resting position and the pin 68 rests against one end of the groove 74. The arm 38 of the main control member 34 extends within the groove 74 of the latch 56 and rests against the pin 68 of the carriage 62. In the position of FIG. 5 the free length of the groove 74 in the direction E is equal to or greater than the stroke of the latch from the closed position to the open position.

Starting from the closed position of FIG. 5, a pressure on the control bar 26 causes an upward movement of the control projection 35. This movement of the control projection 35 causes an oscillation about the axis B of the main control member 34, as shown in FIG. 6. The arm 38 of the control member 34 acts on the pin 68 and pushes the carriage 62 towards the open position. The pin 68 of the carriage 62 is in abutment against one end of the groove 74 and pushes the latch 56 into its open position. The movement of the carriage 62 also causes an oscillation of the levers 76 (FIGS. 2 and 4) about their respective articulation axes. The levers 76 drive an opening movement of the rods 78.

The opening command can also be imparted by rotation of the auxiliary control member 88. In fact, the rotation of the auxiliary control member 88 produces the displacement of the carriage 62 from the resting position to the open position, and consequently leads to the displacement of the latch 56 from the closed position to the open position.

When the thrust on the control bar 26 ceases, the bar 26 returns to its resting position. The latch 56 returns to its closed position under the thrust of the springs 60 and during this movement pushes the carriage 62 into the resting position. The main control member 34 also reverts to its resting position of FIG. 5 thanks to the thrust of the pin 68.

When the carriage 62 is in its resting position illustrated in FIG. 5 the latch 56 is free to move towards its open position without moving the carriage 62. In this way, when the door closes, the latch 56 retracts upon making contact with its fixed counterpart without, however, moving the carriage 62 and the rods 78.

The lock 28 is configured so that it can be mounted indifferently on the right support 22 or on the left support 24, without the need for configuration operations. FIG. 2 shows the lock 28 with the orientation used for its assembly on the left support 22. In the case wherein the lock 28 has to be mounted on the right support 24, it is sufficient to rotate the lock 28 by 180° about the axis G with respect to the position illustrated in FIG. 2.

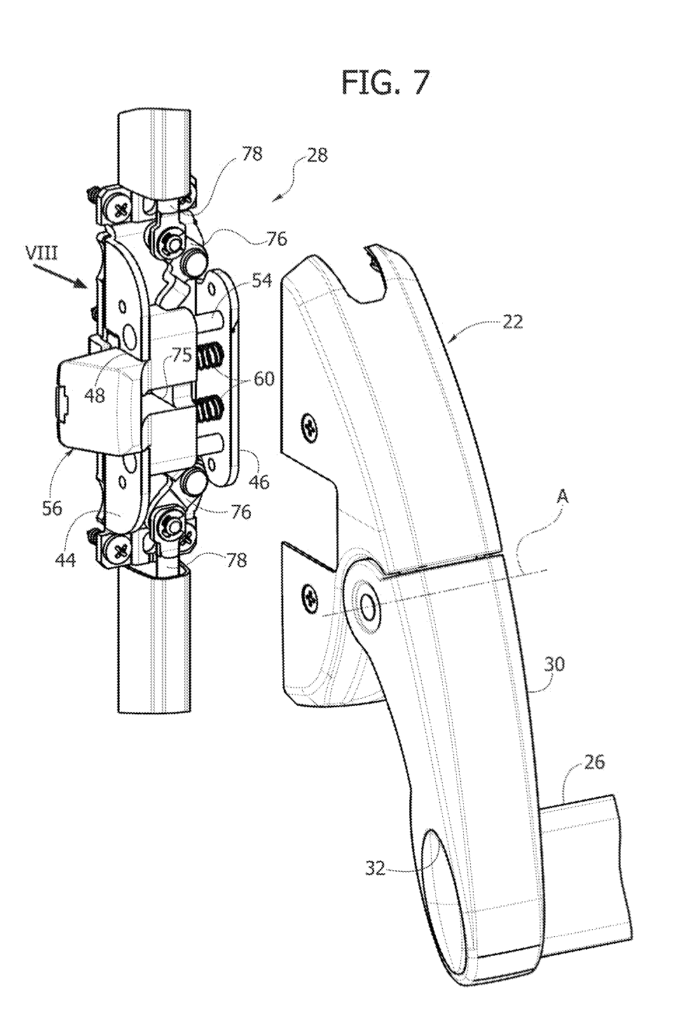

FIGS. 7 to 10 illustrate a second embodiment of the anti-panic opening device according to the present invention. The elements corresponding to those previously described are indicated using the same reference numerals.

In this second embodiment carriage 62 is not provided for.

As in the case described above, the latch 56 is movable with respect to the base 40 in the main rectilinear direction E and is guided along this direction by the pins 54 which engage the corresponding holes 58 of the latch 56.

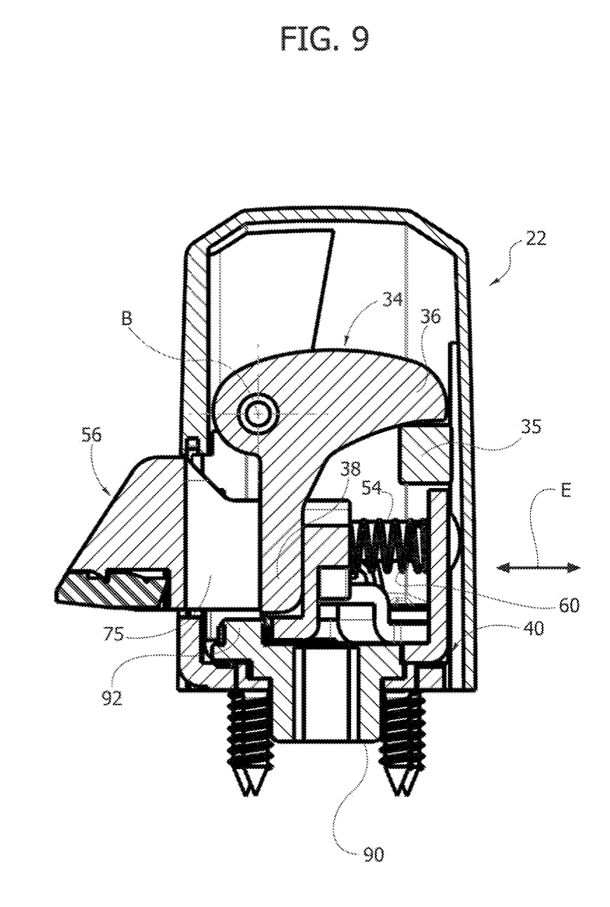

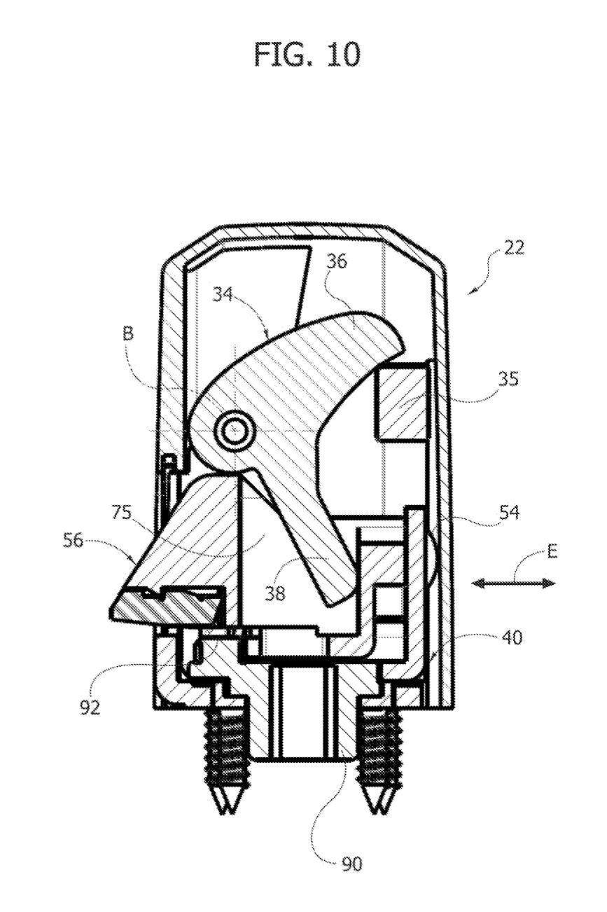

With reference to FIGS. 9 and 10, also in this case the support 22 is equipped with a main control member 34 articulated about an axis B orthogonal to the main rectilinear direction E. The first arm 36 of the main control member cooperates in relation to the support with the control projection 35 which moves towards the top in the representation of FIGS. 9 and 10 as a result of pressure on the control bar 26 (visible in FIG. 7). The second arm 38 of the main control member 34 is inserted into the groove 75 of the latch 56.

As is understood from FIGS. 9 and 10, following the upward movement of the control projection 35 the main control member 34 oscillates about axis B and, through the arm 38, moves the latch 56 from the closed position of FIG. 9 to the open position of FIG. 10 against the thrust of springs 60. When the pressure ceases on the control bar 26, the springs 60 return the latch 56 to the closed position of FIG. 9.

In the closed position of the latch 56 shown in FIG. 9, the free length of the groove 75 in the main direction E is equal to or greater than the stroke of the latch 56 from the closed position to the open position. In this way, during the closing of the leaf, the latch 56 is free to move from the closed position to the open position without interfering with the arm 38 of the main control member 34. There may also be interference between the latch 56 and the arm 38 but the movement of the latch 56 from the closed position to the open position would in any case be guaranteed, as the main control member 34 is free to rotate.

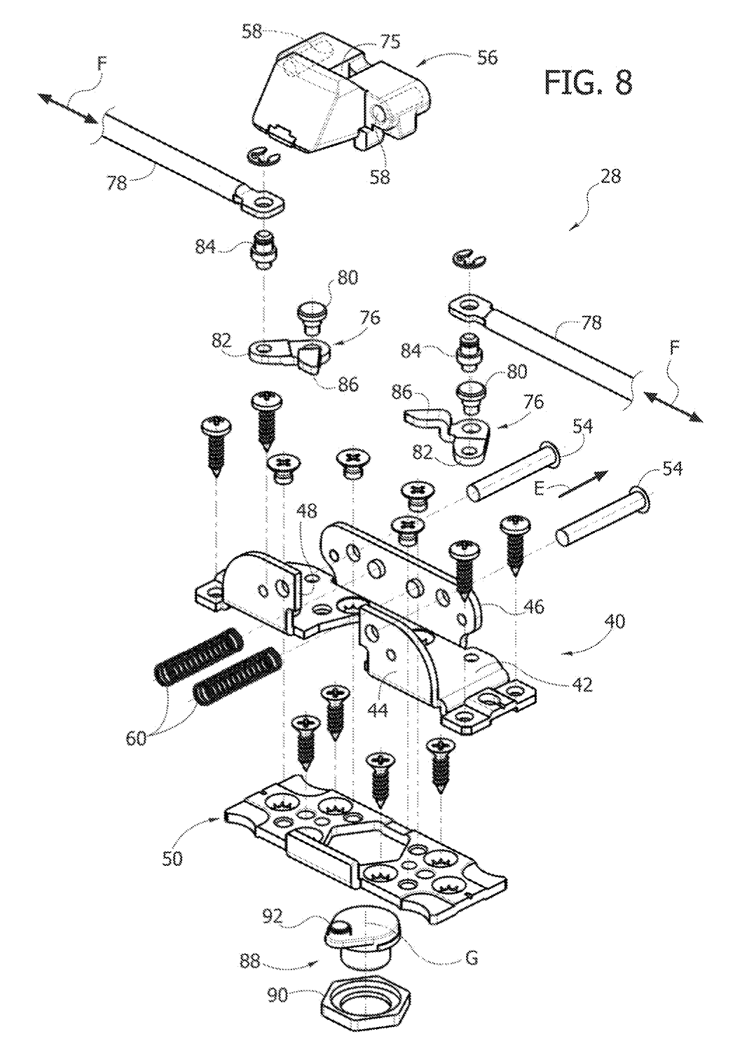

With reference to FIG. 8, in this second embodiment, the second arms 86 of the levers 76 rest directly on the latch 56. During the movement from the closed position to the open position the latch 56 pushes on the second arms 86 and causes the levers 76 to oscillate about their respective pins 80. The oscillation of the levers 76 about the pins 80 controls the movement of the rods 78 in the direction F through the levers 82 connected to the pins 84.

The eccentric pin 92 of auxiliary control member 88 acts directly on the latch 56. A rotation of the auxiliary control member 92 about the axis G controls the movement of the latch 56 from the closed position to the open position against the thrust of springs 60.

Of course, without prejudice to the principle of the invention, the details of construction and the embodiments may be varied with respect to what is described and illustrated without thereby departing from the scope of the invention as defined by the claims that follow.

1. Anti-panic opening device for doors, comprising a left support and a right support bearing respective main control members and a lock mountable on the left support or on the right support, wherein the lock comprises:
a base bearing a linear guide extending along a main rectilinear direction,
a latch which engages said linear guide and is movable relative to the base along said main direction between a closed position and an open position, wherein the latch has a groove elongated in said main direction,
at least one elastic element disposed between the base and the latch, to push the latch towards said closed position,
wherein said main control members are articulated to the respective support about an axis orthogonal to said main direction and wherein the main control member of the support associated with the lock has an arm which extends into said groove and cooperates with the latch in relation to the thrust.

2. Device according to claim 1, wherein in the closed position of the latch said groove has a free length in said main direction adapted to allow a stroke of the latch from the closed position to the open position.

3. Device according to claim 1, further comprising a carriage movable relative to the base along said main direction between a resting position and an open position, the carriage having a pin that slidably engages said groove of the latch.

4. Device according to claim 1, wherein said base carries a pair of levers articulated to the base, each of said levers having a first arm articulated to a respective vertical control rod and a second arm cooperating with said latch or with said carriage.

5. Device according to claim 1, comprising an auxiliary control member rotatable relative to said base about an axis orthogonal to said main direction, said auxiliary control member having an eccentric pin which cooperates with said latch or with said carriage.
